(19) United States
(12) Patent Application Publication
(10) Pub. No.: US 2009/0103666 A1
(43) Pub. Date: Apr. 23, 2009

(54) CHANNEL ESTIMATION FOR RAPID DISPERSIVE FADING CHANNELS

(75) Inventors: Ming Zhao, Australian Capital Territory (AU); Zhenning Shi, Australian Capital Territory (AU); Mark Reed, Australian Capital Territory (AU)

Correspondence Address: SNELL & WILMER LLP (OC), 600 ANTON BOULEVARD, SUITE 1400, COSTA MESA, CA, 92626, US

(73) Assignee: NATIONAL ICT AUSTRALIA LIMITED, Eveleigh ,NSW (AU)

(21) Appl. No.: 12/295,713

(22) PCT Filed: Mar. 30, 2007
(86) PCT No.: PCT/AU2007/000415

§ 371 Date: Dec. 11, 2008

(30) Foreign Application Priority Data
Apr. 3, 2006 (AU) 200690172.3

(51) Int. Cl. H04L 27/06

(52) U.S. Cl. 375/341

(57) ABSTRACT

This invention addresses the problem of channel estimation in fast fading communications channels, particularly for OFDM systems. It finds wide application in existing and future systems such as WLAN and WiMax. In particular, the invention involves a method of channel estimation and data detection for rapid dispersive fading channels due to high mobility. The invention involves decoding a symbol of the received transmission by retrieving pilot tones from it and using these to estimate variations in the channel frequency response using an iterative maximum likelihood channel estimation process, in which the estimation process comprises the following steps: In a first iteration, deriving soft decoded data information, that is information having a confidence value or reliability associated with it, from the estimates of the channel frequency response for the symbol obtained from pilot tones. And, in at least a second iteration using the soft decoded data information as virtual pilot tones together with the pilot tones to re-estimate the channel frequency response for the symbol. In other aspects the invention concerns a receiver and software designed to perform the method.

### TECHNICAL FIELD

This invention addresses the problem of channel estimation in fast fading communications channels, particularly for OFDM systems. It finds wide application in existing and future systems such as WLAN and WiMax. In particular, the invention involves a method of channel estimation and data detection for rapid dispersive fading channels due to high mobility. In other aspects the invention concerns a receiver and software designed to perform the method.

### BACKGROUND ART

Orthogonal frequency division multiplexing (OFDM) modulation is a promising technique for achieving the high data rate that will be required for transmission in the next generation wireless mobile communications. OFDM has been adopted in several wireless standards such as digital audio broadcasting (DAB), digital video broadcasting (DVB-T), the IEEE 802.11a Local Area Network (LAN) standard and the IEEE 802.16a Metropolitan area network (MAN) standard.

OFDM is a block modulation scheme where a block of N information data is transmitted in parallel on N subcarriers. More specifically, the OFDM modulator is implemented as an inverse discrete Fourier transform (IDFT) on the block of N information symbols followed by a digital to analog converter (DAC). The block of N information data are usually referred to as one OFDM symbol in time domain. The time duration of an OFDM symbol is N times larger than that of a single-carrier system. This characteristic makes OFDM system robust to frequency selective fading channel environment.

One advantage of OFDM is its ability to convert a frequency selective fading channel into a parallel collection of frequency flat fading subchannels. Another advantage is that the cyclic prefix (CP) of each OFDM symbol completely eliminates Inter-symbol Interference (ICI) effects. Another advantage of OFDM is spectral efficiency. The subcarriers have the minimum frequency separation required to maintain orthogonality of their corresponding time domain waveforms, as a result the signal spectra corresponding to different subcarriers overlap in frequency. Moreover, OFDM can be implemented by fast signal processing algorithms such as inverse fast fourier transform (IFFT) and fast fourier transform (FFT) at the transmitter and receiver.

With knowledge of the channel state information, coherent detection can be performed on OFDM system, with a 3 dB gain in signal-to-noise ratio (SNR) over differential detection techniques. Current OFDM systems assume the channel is static within one OFDM frame, and use channel estimates obtained from the preamble to recover the rest of the data symbols within the frame. However, this technique will fail in a rapid dispersive fading channel with high mobility. Furthermore, time variation of the channel even within a single OFDM symbol does occur in the high Doppler spread situation, and this may introduce intercarrier interference (ICI) that destroys the orthogonality among the subcarriers. Therefore, a rapid dispersive fading channel with both time and frequency selectivity makes channel estimation and tracking a challenging problem in OFDM systems.

For the purposes of accurate channel estimation and tracking of OFDM, pilot symbols are often multiplexed into the blocks before transmission. Channel estimation can then be performed at the receiver by interpolation. Many techniques have been proposed, such as:
A maximum likelihood estimator (MLE) in the time domain, which is basically a least square (LS) approach over all pilot subcarriers.
A channel estimator based on the singular value decomposition (SVD) or frequency domain filtering. Time domain filtering has also been proposed to further improve the channel estimator.
By exploring the correlation of channel frequency response at different times and frequencies. A robust minimum mean-square-error (MMSE) channel estimator (MMSEE) in the time domain, where the channel frequency response is obtained by taking the FFT of temporal channel estimates. This work has been extended to OFDM systems with transmitter diversity using space-time coding (STC).
Further simplification of the channel estimation has been proposed using a special training sequence and the channel estimates in the previous OFDM symbol to avoid matrix inversion.
Furthermore, an enhanced channel estimation has been proposed that makes use of estimated channel delay profiles in multiple-input and multiple-output (MIMO). However, all the channel estimation techniques mentioned above assume that the channel remains constant for at least one OFDM symbol duration.

Other techniques have been proposed that do not rely on this assumption, for instance:
A linear MMSE (LMMSE) channel estimator has been proposed in the time domain that allocates all subcarriers in a given time slot to pilots.
A linear interpolation method has been proposed to estimate channel impulse response between two channel estimates of adjacent OFDM symbols in a slow varying multipath fading channel.
A channel estimator based on linear interpolation of partial channel information and a LS approach.
A wiener filtering approach utilizing the continuous fourier transform instead of a discrete transform at the receiver.
Modeling the channel response as a 2-D polynomial surface function with MMSE based detection.
Approximating a LMMSE estimation by representing the channel in basis expansion model (BEM) and obtaining the channel impulse response from interpolation of partial channel information using discrete orthogonal legendre polynomials.
Channel estimation using FFT and specific time-domain pilot signals to achieve low complexity. However, due to the existing utilization of time-domain pilot signals, it may not be compatible with existing OFDM standards.
A data-derived channel estimation has been proposed that feeds back hard decision data, that is decoded bits having a value of “0” or “1”, to re-estimate channel state information. This method requires fewer pilots by using hard decision data information. However, the re-estimated channel information is only used in the initial channel estimation for the next OFDM symbol rather than re-detection of the current OFDM symbol, and the hard decision data have to be re-encoded and re-modulated before channel estimation. Furthermore, the reliability of the channel estimation depends on the accuracy of the hard decision data symbols to avoid error propagation.

From an implementation point of view, the MMSE based channel estimation approach needs both time and frequency statistics of channel state information, which is a (time-varying) random quantity and usually unknown. This approach is also more complicated due to the frequent matrix inversion required.

On the other hand, the MLE based approach treats channel state information as an unknown deterministic quantity, and no information on the channel statistics or the operating SNR is required, which is more practical. MLE provides a minimum-variance unbiased (MVU) estimator which achieves the Cramer-Rao lower bound (CRLB). No further improvement of Mean Square Error (MSE) is possible as long as the channel state information is treated as a deterministic quantity. Compared to the MMSE based approach, MLE is more practical although theoretically it has degraded performance. However, MLE requires a minimum number of pilots determined by the maximum channel delay spread.

The notations used in this specification are as follows. Matrices and vectors are denoted by symbols in bold face and (•)*, (•)^{T} and (•)^{H} represent complex conjugate, transpose and Hermitian transpose. E{•} denotes the statistical expectation. [X]_{i,j} indicates the (i,j)th elements of a matrix X, and similarly, [x]ᵢ indicates the element i in a vector x. Finally, {x} represents the sequences.

### DISCLOSURE OF THE INVENTION

A method of channel estimation and data detection for transmissions over a multipath channel, comprising the following steps:
Receiving a transmission over a communications channel, wherein the transmission comprises a series of frames wherein each frame comprises a series of blocks of information data, or symbols, wherein each symbol is divided into multiple samples which are transmitted in parallel using multiple subcarriers, and wherein pilot tones are inserted into each symbol to assist in channel estimation and data detection.
Decoding a symbol of the received transmission by retrieving pilot tones from it and using these to estimate variations in the channel frequency response using an iterative maximum likelihood channel estimation process, in which the estimation process comprises the following steps:
In a first iteration, deriving soft decoded data information, that is information having a confidence value or reliability associated with it, from the estimates of the channel frequency response for the symbol obtained from pilot tones.
And, in at least a second iteration using the soft decoded data information as virtual pilot tones together with the pilot tones to re-estimate the channel frequency response for the symbol.

In the first iteration, an initial estimation stage, a coarse channel frequency response is obtained by tracking the channel variation through low-pass filtering the channel dynamics obtained at pilot positions. Frequency domain moving average window (MAW) filtering may be applied to reduce the estimation noise.

In the second iteration, the iterative estimation stage, both pilot symbols and soft decoded data information are used jointly to estimate channel frequency response. Again, frequency domain MAW filtering may be applied to reduce the estimation noise.

A maximum ratio combining (MRC) principle may be used to derive optimal weight values for the channel estimates in the frequency domain and time domain MAW filtering.

After the second and subsequent iterations a maximum likelihood (ML) principle may be used to obtain the final channel estimates.

Alternatively, after the second and subsequent iterations a minimum mean-square error (MMSE) principle may be used to obtain the final channel estimates.

The iteration process may be performed in the frequency domain, in which case there is no additional complexity introduced by transforming channel impulse response to channel frequency response as in conventional time domain channel estimation.

In each case time domain MAW filtering may be applied, after the frequency domain filtering to further reduce the estimation noise. The filtering weights may be determined by the correlation between consecutive symbols.

This procedure may be repeated, at least for a third iteration, until a selected end point is reached.

A preamble may be included in each frame transmitted. The preamble, pilots and soft decoded data may all be used to track the channel frequency response in every symbol. The channel estimates may be the joint weighting and averaging among these three attributes such that the insertion of a large number of pilot tones is not necessary.

A turbo code instead of convolutional code or low density parity check (LDPC) may be used in data decoding. A turbo code typically consists of a concatenation of at least two or more systematic codes. A systematic code generates two or more bits from an information bit of a symbol, of which one of these two bits is identical to the information bit. The systematic codes used for turbo encoding are typically recursive convolutional codes, called constituent codes. Each constituent code is generated by an encoder that associates at least one parity data bit with one systematic or information bit. The parity data bit is generated by the encoder from a linear combination, or convolution, of the systematic bit and one or more previous systematic bits. The bit order of the systematic bits presented to each of the encoders is randomized with respect to that of a first encoder by an interleaver so that the transmitted signal contains the same information bits in different time slots. Interleaving the same information bits in different time slots provides uncorrelated noise on the parity bits. A parser may be included in the stream of systematic bits to divide the stream of systematic bits into parallel streams of subsets of systematic bits presented to each interleaver and encoder. The parallel constituent codes are concatenated to form a turbo code, or alternatively, a parsed parallel concatenated convolutional code.

There need be no matrix inversion in the proposed technique as pilots and soft coded data may simply be correlated with received signal to decode symbols.

The invention may be applied to rapid dispersive fading channels with severe ICI due to longer OFDM symbol duration and high SNR region of interest. It can be also applied to MIMO-OFDM or MC-CDMA system with transmitter and receiver diversities.

Furthermore, frequency offset and timing offset estimation and tracking can be incorporated within the iterative channel estimation.

Simulations show that the proposed iterative channel estimation technique can approach the performance of those with perfect channel state information within a few iterations. What is more, the number of pilot tones required for the proposed system to function is small, which results in a negligible throughput loss.

In another aspect the invention is a receiver able to estimate channel variation and detect data received over a multipath channel, the receiver comprising:
A reception port to receive a transmission over a communications channel, wherein the transmission comprises a series of frames wherein each frame comprises a series of blocks of information data, or symbols, wherein each symbol is divided into multiple samples which are transmitted in parallel using multiple subcarriers, and wherein pilot tones are inserted into each symbol to assist in channel estimation and data detection.
A decoding processor to decode a symbol of the received transmission by retrieving pilot tones from it and using these to estimate variations in the channel frequency response using an iterative maximum likelihood channel estimation process, in which the processor performs the estimation process comprises the following steps:
In a first iteration, deriving soft decoded data information, that is information having a confidence value or reliability associated with it, from the estimates of the channel frequency response for the symbol obtained from pilot tones.
And, in at least a second iteration using the soft decoded data information as virtual pilot tones together with the pilot tones to re-estimate the channel frequency response for the frame.

In a further aspect the invention is computer software to perform the method.

### BRIEF DESCRIPTION OF THE DRAWINGS

The invention will now be described with reference to the accompanying drawings, in which:

FIG. 1 is a block diagram of an OFDM system with iterative turbo channel estimation.

FIG. 2 is a graph showing ICI Power for IMT-2000 vehicular-A channel with central frequency of 5 GHz and 256 subcarriers.

FIG. 3 is a graph showing a normalized correlation between channel frequency response at subcarrier 5 and other subcarrier for IMT-2000 vehicular-A channel at 333 kmh with central frequency of 5 GHz.

FIG. 4 is graph showing a normalized correlation of channel frequency response at subcarrier 5 between OFDM symbol 10 and consecutive OFDM symbols for IMT-2000 vehicular-A channel at 333 kmh with central frequency of 5 GHz.

FIG. 5 is a graph showing a complexity comparison among iterative turbo MLE, conventional pilot-aided MLE and conventional pilot-aided MMSE.

FIG. 6 is a series of graphs showing performance of an OFDM system with the proposed iterative turbo ML channel estimation. FIG. 6(a) shows the Bit Error rate. FIG. 6(b) shows the Symbol Error rate. FIG. 6(c) shows the Frame Error rate. And, FIG. 6(d) shows the Mean Square error.

FIG. 7 is a series of graphs showing performance between an OFDM system with the proposed iterative turbo ML channel estimation and an OFDM system with conventional pilot-aided ML channel estimation. FIG. 7(a) shows the Bit Error rate. FIG. 7(b) shows the Symbol Error rate. FIG. 7(c) shows the Frame Error rate. And, FIG. 7(d) shows the Mean Square error.

FIG. 8 is a series of graphs showing performance of an OFDM system with the proposed iterative turbo MMSE channel estimation. FIG. 8(a) shows the Bit Error rate. FIG. 8(b) shows the Symbol Error rate. FIG. 8(c) shows the Frame Error rate. And, FIG. 8(d) shows the Mean Square error.

FIG. 9 is a series of graphs showing performance between an OFDM system with the proposed iterative turbo MMSE channel estimation and an OFDM system with conventional pilot-aided ML channel estimation. FIG. 9(a) shows the Bit Error rate. FIG. 9(b) shows the Symbol Error rate. FIG. 9(c) shows the Frame Error rate. And, FIG. 9(d) shows the Mean Square error.

### BEST MODE OF THE INVENTION

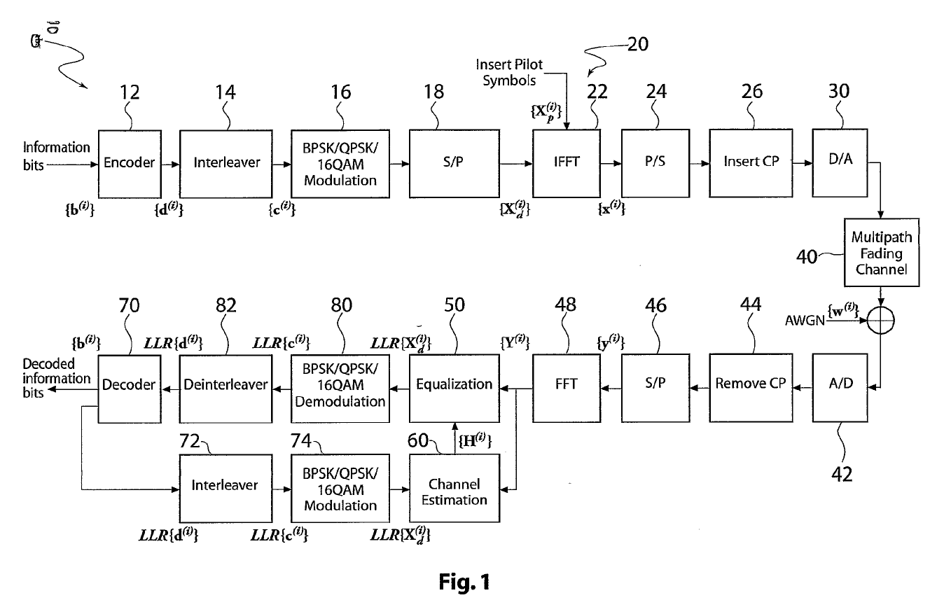

A block diagram of a discrete-time OFDM system 10 with N subcarriers is shown in FIG. 1. The information bits {b⁽ⁱ⁾} are first encoded 12 into coded bits sequences {d⁽ⁱ⁾}, where i is the time index. These coded bits are interleaved 14 into a new sequence of {c⁽ⁱ⁾}, mapped 16 into M-ary complex symbols and serial-to-parallel (S/P) converted 18 to a data sequence of {(X)_{d}⁽ⁱ⁾}. Pilot sequences {(X)_{P}⁽ⁱ⁾} are inserted 20 into data sequences {(X)_{d}⁽ⁱ⁾} at position P(p) to form a OFDM symbol of N frequency domain signals represented as vector X⁽ⁱ⁾=[X⁽ⁱ⁾(0),X⁽ⁱ⁾(1), . . . , X⁽ⁱ⁾(N−1)]^{T}. By applying IDFT 22 on {(X)⁽ⁱ⁾}, which is given by:

$${x}^{( i )} ( n ) = \frac{1}{\sqrt{N}} {\sum }_{k = 0}^{N - 1} {X}^{( i )} ( k ) \cdot exp ( \frac{j 2 π kn}{N} ) , \qquad ( 1 )$$

where 0≦n≦N−1. After adding the CP 26 with length G, the OFDM symbol is converted into time domain sample vector x⁽ⁱ⁾=[x⁽ⁱ⁾(−G),x⁽ⁱ⁾(−G+1), . . . , x⁽ⁱ⁾(N−1)]^{T}. These time domain samples are digital to analog converted 30 and transmitted over the multipath fading channel 40.

The multipath fading channel can be modeled as time-variant discrete impulse response h⁽ⁱ⁾(n,l) representing the fading coefficient of the lth path at time n for ith OFDM symbol. The fading coefficients are modeled as zero mean complex Gaussian random variables. Based on the wide sense stationary uncorrelated scattering (WSSUS) assumption, the fading coefficients in different path are statistically independent. However, for a particular path, the fading coefficients are correlated in time and have a Doppler power spectrum density which is given by:

$$S ( f ) = \{ \begin{matrix}\frac{1.5}{π {f}_{m} \cdot \sqrt{1 - {( f / {f}_{m} )}^{2}}} & \vert f \vert \leq {f}_{m} \\ 0 & otherwise ,\end{matrix} \qquad ( 2 )$$

where fₘ=υ/λ is the maximum doppler frequency at mobile speed υ, and λ is the wave length at carrier frequency f_{c}. Hence, the autocorrelation function of h⁽ⁱ⁾(n,l) is given by:

E{h⁽ⁱ⁾(n,l)·h⁽ⁱ⁾(m,l)*}=αₗ·J₀(2π(n−m)fₘTₛ), (3)

where J₀(•) is the first kind of Bessel function of zero order. Tₛ=1/BW is the sample time, and BW is the bandwidth of OFDM system. αₗ is the power of lth path, which is normalized as:

$${\sum }_{l = 0}^{L - 1} E \{ {‖ {h}^{( i )} ( n , l ) ‖}^{2} \} = {\sum }_{l = 0}^{L - 1} {α}_{l} = 1 , \qquad ( 4 )$$

where the number of fading taps L is given by τₘₐₓ/Tₛ.

Up to this point the transmission side of the system is conventional. The following analysis demonstrates that a new approach to receiver design is feasible.

Assume that the CP is longer or at least equal to the maximum channel delay spread L, i.e. L≦G at the receiver end, after removing the CP 44, the sampled received signal is characterized in following tapped-delay-line model:

$${y}^{( i )} ( n ) = {\sum }_{l = 0}^{L - 1} {h}^{( i )} ( n , l ) {x}^{( i )} ( n - l ) + {w}^{( i )} ( n ) , \qquad ( 5 )$$

where w⁽ⁱ⁾(n) is the additive white Gaussian noise (AWGN) with zero mean and variance of σ_{w}². In the range of 0≦n≦N−1, the received signal y⁽ⁱ⁾(n) is not corrupted by previous OFDM symbol due to the CP added to the time domain samples as a guard interval (GI). Thus, the received signal in time domain after removing the CP can be written as:

$${y}^{( i )} ( n ) = \frac{1}{\sqrt{N}} {\sum }_{k = 0}^{N - 1} {X}^{( i )} ( k ) {e}^{j 2 π nk / N} {\sum }_{l = 0}^{L - 1} {h}^{( i )} ( n , l ) {e}^{- j 2 π lk / N} + {w}^{( i )} ( n ) , \qquad ( 6 )$$

The demodulated signal in the frequency domain is obtained by taking the DFT 48 of

$$\begin{matrix}{y}^{( i )} ( n ) as \text{:} & \\ \begin{matrix}{Y}^{( l )} ( m ) = \frac{1}{\sqrt{N}} {\sum }_{n = 0}^{N - 1} {y}^{( i )} ( n ) {e}^{- j 2 π mn / N} \\ = \frac{1}{\sqrt{N}} {\sum }_{n = 0}^{N - 1} \\ \{ {\sum }_{l = 0}^{L - 1} {h}^{( l )} ( n , l ) \frac{1}{\sqrt{N}} {\sum }_{k = 0}^{N - 1} {X}^{( i )} ( k ) {e}^{j 2 π ( n - l ) k / N} + {w}^{( i )} ( n ) \} \\ {e}^{- j 2 π mn / N} \\ = {\sum }_{k = 0}^{N - 1} {\sum }_{l = 0}^{L - 1} \{ \frac{1}{N} {\sum }_{n = 0}^{N - 1} {h}^{( i )} ( n , l ) {e}^{- j 2 π lk / N} \} \\ {X}^{( i )} ( k ) {e}^{- j 2 π ( m - k ) n / N} + \frac{1}{\sqrt{N}} {\sum }_{n = 0}^{N - 1} {w}^{( i )} ( n ) {e}^{- j 2 π mn / N} \\ = {H}_{m , m}^{( i )} {X}^{( i )} ( m ) + {\sum }_{k \neq m} {H}_{m , k}^{( i )} {X}^{( i )} ( k ) + {W}^{( i )} ( m ) ,\end{matrix} & ( 7 ) \\ where & \\ {H}_{m , m}^{( i )} = \frac{1}{N} {\sum }_{n = 0}^{N - 1} {\sum }_{i = 0}^{L - 1} {h}^{( i )} ( n , l ) {e}^{- j 2 π l m / N} = \frac{1}{N} {\sum }_{n = 0}^{N - 1} {ℏ}_{m}^{( i )} ( n ) , & ( 8 ) \\ {H}_{m , k}^{( i )} = \frac{1}{N} {\sum }_{n = 0}^{N - 1} \{ {\sum }_{l = 0}^{L - 1} {h}^{( i )} ( n , l ) {e}^{- j 2 π lk / N} \} {e}^{- j 2 π ( m - k ) n / N} \\ = \frac{1}{N} {\sum }_{n = 0}^{N - 1} {ℏ}_{k}^{( i )} ( n ) {e}^{- j 2 π ( m - k ) n / N} , & ( 9 ) \\ and & \\ {W}^{( i )} ( n ) = \frac{1}{\sqrt{N}} {\sum }_{n = 0}^{N - 1} {w}^{( i )} ( n ) {e}^{- j 2 π mn / N} , & ( 10 )\end{matrix}$$

are the multiplicative distortion at the desired subchannel, the ICI, and AWGN after DFT respectively. ₘ⁽ⁱ⁾(n) is the channel frequency response of subcarrier m at time n in ith OFDM symbol. If the channel is assumed to be time-invariant during a OFDM symbol period, ₖ⁽ⁱ⁾(n) is constant in equation (9) and H_{m,k}⁽ⁱ⁾ vanishes. In this case, Y⁽ⁱ⁾(m) in equation (7) only contains the multiplicative distortion, which can be easily compensated for by a one-tap frequency domain equalizer if channel state information is known.

Written in concise matrix form, denoting the received time-domain signal after removing CP as N×1 vector y⁽ⁱ⁾=[y⁽ⁱ⁾(0),y⁽ⁱ⁾(1), . . . , y⁽ⁱ⁾(N−1)]^{T}, and the time-domain channel matrix as an N×N matrix as follows,

$${h}^{( i )} = [ \begin{matrix}{h}_{0 , 0}^{( i )} & 0 & 0 & ⋯ & 0 & {h}_{0 , L - 1}^{( i )} & {h}_{o , L - 2}^{( i )} & ⋯ & {h}_{0 , 1}^{( i )} \\ {h}_{1 , 1}^{( i )} & {h}_{1 , 0}^{( l )} & 0 & ⋯ & 0 & 0 & {h}_{1 , L - 1}^{( i )} & ⋯ & {h}_{1 , 2}^{( i )} \\ ⋯ & ⋯ & ⋯ & ⋯ & ⋯ & ⋯ & ⋯ & ⋯ & ⋯ \\ 0 & 0 & 0 & ⋯ & {h}_{N - 1 , L - 1}^{( i )} & {h}_{N - 1 , L - 2}^{( i )} & ⋯ & ⋯ & {h}_{N - 1 , 0}^{( i )}\end{matrix} ] , \qquad ( 11 )$$

N×N IDFT matrix with [F]_{m,n}=e^{j2πmn/N}/\sqrt{N}, and AWGN as N×1 vector w⁽ⁱ⁾=[w⁽ⁱ⁾(0),w⁽ⁱ⁾(1), . . . , w⁽ⁱ⁾(N−1)]^{T}, equation (6) can be written as:

y⁽ⁱ⁾=h⁽ⁱ⁾FX⁽ⁱ⁾+w⁽ⁱ⁾, (12)

Denoting the received frequency domain signal after DFT as N×1 vector Y⁽ⁱ⁾=[Y⁽ⁱ⁾(0),Y⁽ⁱ⁾(1), . . . , Y⁽ⁱ⁾(N−1)]^{T}, equation (7) becomes:

Y⁽ⁱ⁾=F^{H}y⁽ⁱ⁾=F^{H}h⁽ⁱ⁾FX⁽ⁱ⁾+F^{H}w⁽ⁱ⁾=H⁽ⁱ⁾X⁽ⁱ⁾+W⁽ⁱ⁾, (13)

where H⁽ⁱ⁾=F^{H}h⁽ⁱ⁾F and W⁽ⁱ⁾=F^{H}w⁽ⁱ⁾. As discussed above, in the case of time-invariant channel, H⁽ⁱ⁾ is a diagonal matrix with [H⁽ⁱ⁾]_{m,m} given by equation (8). On the other hand, in time-variant channel, H⁽ⁱ⁾ has non-trivial off-diagonal elements [H⁽ⁱ⁾]_{m,k} given by equation (9).

A central limit theorem argument is used to model ICI as a Gaussian random process.

Therefore, we only need to estimate the diagonal terms [H⁽ⁱ⁾]_{m,m}. The off-diagonal terms [H⁽ⁱ⁾]_{m,k} causing ICI in can be ignored in the estimation if fₘT_{sym}≦0.08 because the signal-to-interference ratio (SIR) will be above 20 dB. To verify this, we calculate the cross-correlation between any elements in the H⁽ⁱ⁾ matrix as:

$$E \{ {H}_{r , s}^{( i )} \cdot {( {H}_{p , q}^{( i )} )}^{*} \} = \frac{1}{{N}^{2}} {\sum }_{l - 0}^{L - 1} {e}^{- j 2 π ( s - q ) l / N} {α}_{l} \cdot {\sum }_{n = 0}^{N - 1} {\sum }_{m = 0}^{N - 1} {J}_{0} [ 2 π \cdot {f}_{m} ( n - m ) {T}_{s} ] {e}^{- j 2 π ( r - s ) n / N} {e}^{j 2 π ( p - q ) m / N} , \qquad ( 14 )$$

The average power of ICI for a particular subcarrier m is measured by:

$$\begin{matrix}{P}_{ICI}^{m} = E \{ \vert \vert {\sum }_{k \neq m} {H}_{m , k}^{( i )} {X}^{( i )} ( m ) {\vert \vert}^{2} \} = \vert \vert {\sum }_{k \neq m} {H}_{m , k}^{( i )} {\vert \vert}^{2} \\ = \frac{1}{{N}^{2}} {\sum }_{k \neq m} {\sum }_{l = 0}^{L - 1} {α}_{l} {\sum }_{n = 0}^{N - 1} {\sum }_{{n}^{′} = 0}^{N - 1} {J}_{0} ( 2 π {f}_{m} ( n - {n}^{′} ) {T}_{s} ) {e}^{- j 2 π ( m - k ) ( n - {n}^{′} ) / N} \\ = \frac{1}{{N}^{2}} {\sum }_{k \neq m} \{ N + 2 {\sum }_{p = 1}^{N - 1} ( N - p ) {J}_{0} ( 2 π {f}_{m} {pT}_{s} ) cos ( \frac{2 π ( m - k ) p}{N} ) \} ,\end{matrix} \qquad ( 15 )$$

and the average power of ICI of OFDM symbol is given by:

$${P}_{ICI} = \frac{1}{N} {\sum }_{m = 0}^{N - 1} {P}_{ICI}^{m} = \frac{N - 1}{N} + \frac{4}{{N}^{3}} {\sum }_{p = 1}^{N - 1} ( N - p ) {J}_{0} ( 2 π {f}_{m} {pT}_{s} ) \cdot {\sum }_{q = 1}^{N - 1} ( N - q ) cos ( \frac{2 π pq}{N} ) , \qquad ( 16 )$$

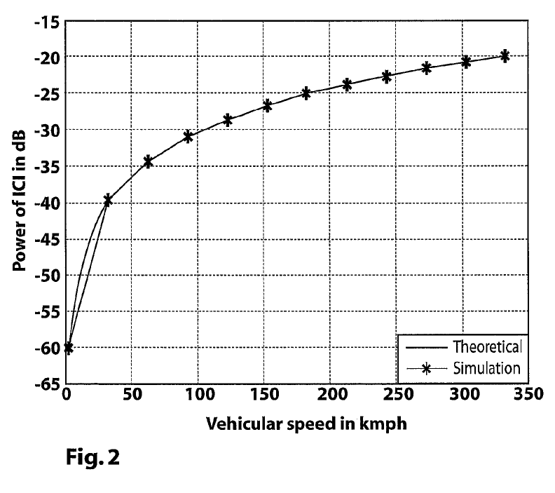

FIG. 2 shows ICI Power for IMT-2000 vehicular-A channel at various mobile speeds with a central frequency of 5 GHz and 256 subcarriers. It can be seen that ICI due to mobile channel in most practical Doppler spreads is not severe. This fact can be used to greatly simplify the channel estimation technique used at the receiver.

The receiver uses a number of iterative receiver algorithms to repeat the data detection and decoding tasks on the same set of received data, and feedback information from the decoder is incorporated into the detection process. This method is called the “turbo principle”, since it resembles the similar principle of that name originally developed for concatenated convolutional codes. This principle of iterative reception has recently been adapted to various communication systems, such as trellis code (TCM) and code division multiple access (CDMA). In all these systems, maximum a posteriori probability (MAP) based techniques, for example, the BCJR algorithm is used exclusively for both data detection and decoding.

Referring again to FIG. 1, it also shows the receiver structure for turbo processing used in channel estimation. In this example, the feedback information, which is the estimation of the probability of coded data bits, is fed back to the channel estimator 60.

In the turbo principle generally, the log likelihood ratio (LLR) is defined as:

$$L L R ( x ) = ln \frac{P ( x = 1 )}{P ( x = 0 )} , \qquad ( 17 )$$

to represent the likelihood of a bit x to be either 1 or 0. Starting from data detection or equalization, the equalizer computes the a posteriori probability (APP's) P(X_{d}⁽ⁱ⁾(m)|Ĥ⁽ⁱ⁾,Y⁽ⁱ⁾(m)) at subcarrier m, given the previous estimated channel frequency response and received symbol, and outputs the extrinsic LLR by subtracting the a priori LLR from (17) as:

$$L L R ( {c}_{{X}_{j}^{( i )} ( m )} ) = ln \frac{P ( {c}_{{X}_{d}^{( i )} ( m )} = 1 \vert {\hat{H}}^{( i )} , {Y}^{( i )} ( m ) )}{P ( {c}_{{X}_{d}^{( i )} ( m )} = 0 \vert {\hat{H}}^{( i )} , {Y}^{( i )} ( m ) )} - ln \frac{P ( {c}_{{X}_{d}^{( i )} ( m )} = 1 )}{P ( {c}_{{X}_{d}^{( i )} ( m )} = 0 )} , \qquad ( 18 )$$

The a priori LLR representing the priori information on the occurrence of probability of coded bit c is provided by decoder 70 into the feedback loop.

For the initial data detection, no a priori information is available, hence,

ln{P(c_{X}_{_{d}}_{⁽ⁱ⁾}₍ₘ₎=1)/P(c_{X}_{_{d}}_{⁽ⁱ⁾}₍ₘ₎=0}=0.

After demodulation at 80 LLR(c⁽ⁱ⁾) is the M-ary demodulated LLR sequence for LLR(X_{d}⁽ⁱ⁾), and LLR(d⁽ⁱ⁾) is the deinterleaved sequence for LLR(c⁽ⁱ⁾) after deinterleaving at 82. We emphasize that LLR(c⁽ⁱ⁾) is independent to LLR(d⁽ⁱ⁾), this emphasis and the concept of treating the feedback as a priori information are the two essential features of the turbo principle. The decoder 70 will compute the APPs P(\hat{d}⁽ⁱ⁾(n)|LLR(d⁽ⁱ⁾)) and outputs the difference:

$$L L R ( {\hat{d}}^{( i )} ( n ) ) = ln \frac{P ( {d}^{( i )} ( n ) = 1 \vert L L R ( {d}^{( i )} ) )}{P ( {d}^{( i )} ( n ) = 0 \vert L L R ( {d}^{( i )} ) )} - ln \frac{P ( {d}^{( i )} ( n ) = 1 )}{P ( {d}^{( i )} ( n ) = 0 )} , \qquad ( 19 )$$

to the data detector. The decoder 70 also computes the information bits estimates:

$${\hat{b}}^{( i )} ( n ) = {arg max}_{b ∈ \{ 0 , 1 \}} P ( {b}^{( i )} ( n ) = b \vert L L R ( {d}^{( i )} ) ) , \qquad ( 20 )$$

Applying the turbo principle, after an initial detection and decoding of a block of received symbols, blockwise data decoding and detection are performed on the same set of received data by operation of the feedback loop. The iterative process stops when certain criterion is met. For example, the maximum number of iterations is exceeded, or the Bit Error Rate (BER) is below the required level, or the MSE is sufficient small.

In the iterative turbo channel estimation, preamble, pilot and soft coded data symbols are used in three stages, which are referred to as the initial coarse estimation stage, the iterative estimation stage, and the final maximum likelihood or minimum mean square error estimation stage. We assume that OFDM symbols are transmitted continuously on a frame basis. Each OFDM frame consists of an OFDM symbol working as a preamble followed by a number of other OFDM data symbols. In the OFDM data symbols, pilot tones are evenly distributed across all available subcarriers.

### Initial Estimation Stage

The initial coarse estimation stage is performed at the first iteration. Frequency and time domain MAW filtering is performed on the estimates from the preamble symbol and pilot tones are applied to obtain the initial coarse channel frequency response. The system model for pilot symbol transmission is given by:

$${Y}^{( i )} ( p ) = {H}_{p , p}^{( i )} \sqrt{{E}_{p}} {X}_{p}^{( i )} ( p ) + {\sum }_{q ∈ pilots , q \neq p} {H}_{p , q}^{( i )} \sqrt{{E}_{p}} {X}_{P}^{( i )} ( q ) + {\sum }_{n \neq p , q} {H}_{p , n}^{( i )} \sqrt{{E}_{d}} {X}_{d}^{( i )} ( n ) + {W}^{( i )} ( p ) , \qquad ( 21 )$$

where Eₚ and E_{d} are the energy of pilot and data symbol, respectively. Pilot-assisted channel frequency response is obtained by LS approach:

$$\begin{matrix}{\hat{H}}_{p , p}^{( i )} = {Y}^{( i )} ( p ) \frac{{( {X}_{P}^{( i )} ( p ) )}^{*}}{\sqrt{{E}_{p}}} \\ = {H}_{p , p}^{( i )} + {\sum }_{q ∈ pilots , q \neq p} {H}_{p , q}^{( i )} {X}_{P}^{( i )} ( q ) {( {X}_{P}^{( i )} ( p ) )}^{*} + \\ = {\sum }_{n \neq p , q} {H}_{p , n}^{( i )} \sqrt{\frac{{E}_{d}}{{E}_{p}}} {X}_{d}^{( i )} ( n ) {( {X}_{P}^{( i )} ( p ) )}^{*} + \\ = \frac{1}{\sqrt{{E}_{p}}} {W}^{( i )} ( p ) {( {X}_{P}^{( i )} ( p ) )}^{*} \\ = {H}_{p , p}^{( i )} + {W}_{P}^{′ ( i )} ( p ) ,\end{matrix} \qquad ( 22 )$$

If we assume the pilot and data symbols are independent, and ICI is sufficient small compared to noise in the signal-to-noise ratio (SNR) region of interest, it can be shown that:

$$\begin{matrix}E \{ {W}_{P}^{′ ( i )} ( p ) \} = {\sum }_{q ∈ pilots , q \neq p} {H}_{p , q}^{( i )} E \{ {X}_{P}^{( l )} ( q ) {( {X}_{P}^{( i )} ( q ) )}^{*} \} + {\sum }_{n \neq p , q} {H}_{p , q}^{( i )} \sqrt{\frac{{E}_{d}}{{E}_{p}}} E \{ {X}_{d}^{( i )} ( q ) {( {X}_{P}^{( i )} ( q ) )}^{*} \} + \frac{1}{\sqrt{{E}_{p}}} E \{ {W}^{( i )} ( p ) {( {X}_{P}^{( i )} ( q ) )}^{*} \} = 0 , \\ and & ( 23 ) \\ E \{ \vert \vert {W}_{P}^{′ ( i )} ( p ) {\vert \vert}^{2} \} = {\sum }_{q ∈ pilots , q \neq p} E \{ \vert \vert {H}_{p , q}^{( i )} {\vert \vert}^{2} \} + \frac{{E}_{d}}{{E}_{p}} {\sum }_{n \neq p , q} E \{ \vert \vert {H}_{p , n}^{( i )} {\vert \vert}^{2} \} + \frac{{σ}_{w}^{2}}{{E}_{p}} = \frac{{σ}_{w}^{2} + {σ}_{ICI}^{2}}{{E}_{p}} = \frac{{σ}_{{w}^{′}}^{2}}{{E}_{p}} , & ( 24 )\end{matrix}$$

The correlation between the channels occupied by pilots and those occupied by data allows pilot-aid channel estimation to work effectively. For example, in the OFDM channel scenario, the statistical correlation between subcarriers r and q is given by: Let r=s and p=q, then (14) can be simplified to:

$$E \{ {H}_{r , r}^{( i )} \cdot {( {H}_{p , p}^{( i )} )}^{*} \} = \frac{1}{{N}^{2}} {\sum }_{l = 0}^{L - 1} {e}^{- j 2 π ( r - p ) l / N} \cdot {α}_{l} \cdot {\sum }_{n = 0}^{N - 1} {\sum }_{m = 0}^{N - 1} {J}_{0} [ 2 π {f}_{m} ( n - m ) {T}_{s} ] , \qquad ( 25 )$$

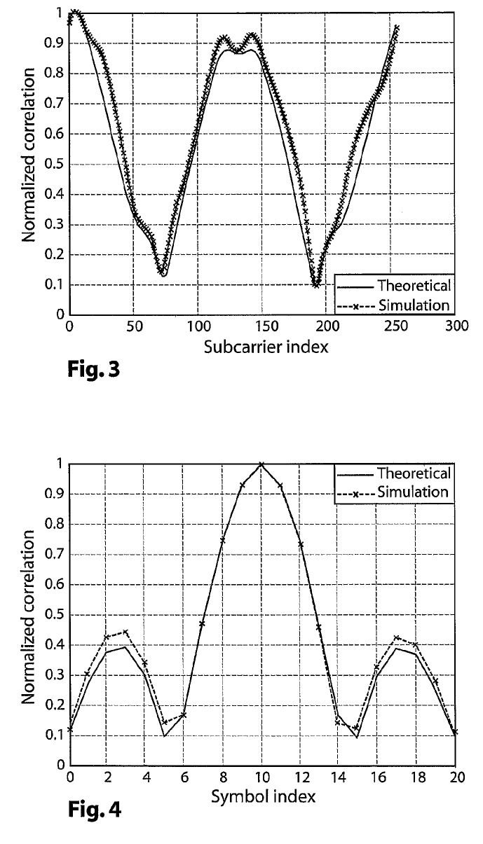

FIG. 3 shows an example of normalized correlation of channel frequency response at subcarrier 5 with other subcarriers for IMT-2000 vehicular-A channel at 333 kmh with a central carrier frequency of 5 GHz. We can see that the channel frequency responses at adjacent subcarriers are highly correlated. Therefore, we can use low-pass filtering techniques such as interpolation and moving-average window (MAW) etc to reconstruct the full channel response from the pilot symbols.

Time domain MAW filtering can be applied to further reduce the estimation noise, given by

$$E \{ {H}_{r , r}^{( i )} \cdot {( {H}_{p , p}^{( j )} )}^{*} \} = \frac{1}{{N}^{2}} {\sum }_{l = 0}^{L - 1} {e}^{- j 2 π ( r - p ) l / N} \cdot {α}_{l} \cdot {\sum }_{n = 0}^{N - 1} {\sum }_{m = 0}^{N - 1} {J}_{0} \{ 2 π {f}_{m} [ n - m + ( i - j ) ( N + CP ) ] {T}_{s} \} , \qquad ( 26 )$$

FIG. 4 shows the correlation of channel frequency response at subcarrier 5 between OFDM symbol 10 and consecutive OFDM symbols for IMT-2000 vehicular-A channel at 333 kmh with a central carrier frequency of 5 GHz. In this case, the adjacent OFDM symbols are highly correlated. Hence, the size of MAW in the time domain can be set to 3 and the filter coefficients can be obtained from normalized correlation values, i.e. {0.9331,1,0.9331}/(0.9331+1+0.9331).

The probability of transmitted bit c in the M-ary symbol LLR(X_{d}⁽ⁱ⁾(m)) given the estimated channel frequency response is calculated as:

$$P ( {Y}^{( i )} ( m ) \vert {\hat{H}}_{m , m}^{( i )} , {c}_{{X}_{d}^{( i )} ( m )} ) = {\sum }_{{c}^{′} \neq c} \{ exp ( - \frac{\vert \vert {Y}^{( i )} ( m ) - {\hat{H}}_{m , m}^{( i )} {X}_{d}^{( i )} ( m ) {\vert \vert}^{2}}{{σ}_{{w}^{′}}^{2}} ) {\prod }_{{c}^{′} \neq c} P ( {c}_{{X}_{d}^{( i )} ( m )}^{′} ) \} , \qquad ( 27 )$$

P(c′_{X}_{_{d}}_{⁽ⁱ⁾}₍ₘ₎) is the a priori information of bits c′_{X}_{_{d}}_{⁽ⁱ⁾}₍ₘ₎ in data symbol X_{d}⁽ⁱ⁾(m). The probability in equation (27) will be used to calculate the LLR(X_{d}⁽ⁱ⁾(m)) by using equation (17) in to form sequence LLR(X_{d}⁽ⁱ⁾) at 50 for M-ary demodulation 80, deinterleaving 82 and decoding 70. The decoder 70 will output the sequence LLR(\hat{d}⁽ⁱ⁾) and feed it back to the channel estimator 60 with interleaving 72 and M-ary modulation 74 as LLR(ĉ⁽ⁱ⁾). The channel estimator 60 will compute the soft coded data information based on LLR(ĉ⁽ⁱ⁾) as in “Iterative (turbo) soft interference cancellation and decoding for coded cdma,” by X. D. Wang and H. V. Poor in IEEE Trans. Commun., vol. 47, no. 7, pp. 1046-1061, July 1999” incorporated herein by reference.

For BPSK the soft coded data is given by:

$${\hat{X}}_{d}^{( i )} ( m ) = tan h \{ \frac{L L R ( {\hat{c}}_{{X}_{d}^{( i )} ( m )} )}{2} \} , \qquad ( 28 )$$

and for gray-coded QPSK the soft coded data is given by:

$${\hat{X}}_{d}^{( i )} ( m ) = \frac{1}{\sqrt{2}} ( \begin{matrix}tan h \{ \frac{L L R ( {\hat{c}}_{0 , {X}_{d}^{( i )} ( m )} )}{2} \} + \\ j tan h \{ \frac{L L R ( {\hat{c}}_{1 , {X}_{d}^{( i )} ( m )} )}{2} \}\end{matrix} ) , \qquad ( 29 )$$

The reference signals that are transmitted at the beginning of data packets, e.g., preambles, can be used to obtain initial estimates of the channel state information. In the multiplex schemes in frequency domain or time domain, channel estimates can be obtained at time or frequency positions where there are preamble signals available. The method also can operate without preamble information. Interpolation and low-pass filtering can be used to get ubiquitous channel estimates and to further reduce the estimation errors. In the following we use the downlink of the OFDM system as an example to illustrate the preamble-based channel estimation approach. There are many variations of this example where the method can still be useful. Assume preamble has index Error! Objects cannot be created from editing field codes, received signal at even subcarriers Y_{Pre}=X_{Pre}H_{Pre}+W_{Pre}, there is no data transmission at the odd subcarriers in order to generate the two identical parts of preamble in time domain. Y_{Pre} is Nᵤₛₑ/2×1 vector. X_{Pre} is (Nᵤₛₑ/2)×(Nᵤₛₑ/2) preamble data diagonal matrix. H_{Pre} is the Nᵤₛₑ/2×1 vector channel frequency response at even subcarriers. W_{Pre} is Nᵤₛₑ/2×1 of white Gaussian noise and ICI with variance Error! Objects cannot be created from editing field codes. LS estimation is applied Ĥ_{P}=X_{P}^{H}X_{P}H_{P}+X_{P}^{H}W_{P}=H_{P}+X_{P}^{H}W_{P}. To obtain the channel frequency response at all subcarriers with reduced error, following 2 steps are performed:
1) Linear interposition

Ĥ_{Pre}(k)={Ĥ_{Pre}(k−1)+Ĥ_{Pre}(k+1)}/2, where k is odd
Since virtual (null or guard) subcarriers are used, at the two edges, the channel frequency response is simply a repeat of the adjacent pilot tone.
2) Moving average smoothing, the window size is set to K

$${\tilde{H}}_{pre} ( n ) = \frac{1}{K} {\sum }_{k = n - ( K - 1 ) / 2}^{n + ( K - 1 ) / 2} {\hat{H}}_{pre} ( k )$$

For the data symbols that follow the preamble symbol, pilot signals are used to track the channel variation over time, given by

\tilde{H}ⁱ=\tilde{H}ⁱ⁻¹+Δ\tilde{H}=\tilde{H}ⁱ⁻¹+Filter(ΔĤ)
where ΔĤ=Ĥₚⁱ−\tilde{H}ₚⁱ⁻¹ is the estimated temporal difference of channel response at pilot positions, and Filter (ΔĤ) is the estimated channel difference between two OFDM symbols based on the difference ΔĤ at pilot positions, subject to a specific low-pass filtering operation. For instance MMSE filter can be applied to ΔĤ if the statistics of channel delay profile is known. Two filtering implementations with less complexity are given as follows:
1) Interpolation, where channel dynamic on a data position is obtained by an appropriate interpolation, e.g., linear interpolation, between those on the nearest pilot positions.
2) Pseudo-inverse filtering according to the maximum likelihood principle. In OFDM scenario, such filter is given by Filter(•)=G(B^{H}B)⁻¹B^{H}. Error! Objects cannot be created from editing field codes. is the Nᵤₛₑ×N_{P} FFT matrix which is extracted from N×N FFT matrix at rows where the subcarriers are used. Error! Objects cannot be created from editing field codes. is designed as N_{P}×N_{P} FFT matrix, where N_{P} is the number of pilot tones. We should keep in mind that the filtering matrix Filter(•)=G(B^{H}B)⁻¹B^{H} can be pre-calculated which tremendously saves the complexity.

In the scenarios that the underlying channel is fast time-dispersive or the packet contains many data symbols, the channel experienced at the beginning of the packet could be drastically different from that at the end of the packet. Therefore, it is crucial to track the channel variation with the aid of pilots. This method is especially useful at the first iteration, where no soft decoding data is available to update the channel estimates.

### Iterative Estimation Stage

From the second iteration onwards, the channel estimator has entered the iterative estimation stage. Similar to the pilot tones, the system model for data symbol transmission is given by:

$${Y}^{( i )} ( m ) = {H}_{m , m}^{( i )} \sqrt{{E}_{d}} {X}_{d}^{( i )} ( m ) + {\sum }_{n \neq m} {H}_{m , n}^{( i )} \sqrt{{E}_{d}} {X}_{d}^{( i )} ( n ) + {\sum }_{p \neq m} {H}_{m , p}^{( i )} \sqrt{{E}_{p}} {X}_{p}^{( i )} ( p ) + {W}^{( i )} ( m ) , \qquad ( 30 )$$

The soft coded data information is now used to estimated the channel:

$$\begin{matrix}\begin{matrix}{\hat{H}}_{m , m}^{( i )} = {Y}^{( i )} ( m ) \frac{{( {X}_{d}^{( i )} ( m ) )}^{*}}{\sqrt{{E}_{d} \vert \vert {\hat{X}}_{d , MAW}^{( i )} {\vert \vert}^{2}}} \\ = {H}_{m , m}^{( i )} \frac{1}{\sqrt{\vert \vert {\hat{X}}_{d , MAW}^{( i )} {\vert \vert}^{2}}} {X}_{d}^{( i )} ( m ) ( {X}_{d}^{( i )} ( m ) ) * \\ + {\sum }_{n \neq m} {H}_{m , n}^{( i )} \frac{1}{\sqrt{\vert \vert {\hat{X}}_{d , MAW}^{( i )} {\vert \vert}^{2}}} {X}_{d}^{( i )} ( n ) {( {X}_{d}^{( i )} ( m ) )}^{*} \\ + {\sum }_{p \neq m} {H}_{m , p}^{( i )} \frac{\sqrt{{E}_{p}}}{\sqrt{{E}_{d} \vert \vert {\hat{X}}_{d , MAW}^{( i )} {\vert \vert}^{2}}} {X}_{P}^{( i )} ( p ) {( {X}_{d}^{( i )} ( m ) )}^{*} \\ + \frac{1}{\sqrt{{E}_{d} \vert \vert {\hat{X}}_{d , MAW}^{( i )} {\vert \vert}^{2}}} {W}^{( i )} ( m ) {( {X}_{d}^{( i )} ( m ) )}^{*} \\ = {H}_{m , m}^{( l )} \frac{1}{\sqrt{\vert \vert {\hat{X}}_{d , MAW}^{( i )} {\vert \vert}^{2}}} {X}_{d}^{( i )} ( m ) {( {X}_{d}^{( i )} ( m ) )}^{*} + {W}_{d}^{′ ( i )} ( m ) \\ \approx {H}_{m , m}^{( l )} \sqrt{\vert \vert {\hat{X}}_{d , MAW}^{( i )} {\vert \vert}^{2}} + {W}_{d}^{′ ( i )} ( m ) ,\end{matrix} & ( 31 ) \\ where & \\ \vert \vert {\hat{X}}_{d , MAW}^{( i )} {\vert \vert}^{2} = E \{ {\hat{X}}_{d , MAW}^{( i )} ( m ) {( {\hat{X}}_{d , MAW}^{( i )} ( m ) )}^{*} \} , & ( 32 )\end{matrix}$$

is the average energy of soft coded data information in the MAW. It can be shown that:

$$\begin{matrix} E \{ {W}_{d}^{′ ( i )} \} = 0 , \\ and & ( 33 ) \\ E \{ \vert \vert {W}_{d}^{′ ( i )} ( m ) {\vert \vert}^{2} \} = {\sum }_{n \neq m} E \{ \vert \vert {H}_{m , n}^{( i )} {\vert \vert}^{2} \} + \frac{{E}_{p}}{{E}_{d}} {\sum }_{p \neq m} E \{ \vert \vert {H}_{m , p}^{( i )} \vert \vert \} + \frac{{σ}_{w}^{2}}{{E}_{d}} = \frac{{σ}_{w}^{2} + {σ}_{ICI}^{2}}{{E}_{d}} = \frac{{σ}_{{w}^{′}}^{2}}{{E}_{d}} , & ( 34 )\end{matrix}$$

The MAW filtering takes the channel estimates from both pilot signals and soft coded data information. If we assume that within the MAW, the channel response is highly correlated, i.e. H_{p,p}⁽ⁱ⁾≈H_{d,d}⁽ⁱ⁾≈H_{m,m}⁽ⁱ⁾, the weighted average for the channel frequency response at subcarrier m is given by:

$$\begin{matrix}{\hat{H}}_{m , m}^{( i )} = & {ω}_{p} {\sum }_{p ε MAW} {\hat{H}}_{p , p}^{( i )} + {ω}_{d} {\sum }_{d ε MAW} {H}_{d , d}^{( i )} \\ = & {ω}_{p} {\sum }_{p ε MAW} ( {H}_{m , m}^{( i )} + {W}_{P}^{′ ( i )} ) + \\ & {ω}_{d} {\sum }_{d ε MAW} ( {H}_{m , m}^{( i )} \sqrt{\vert \vert {\hat{X}}_{d , MAW}^{( i )} {\vert \vert}^{2}} + {W}_{d}^{′ ( i )} ) \\ = & ( {N}_{p} {ω}_{p} + {N}_{d} {ω}_{d} \sqrt{\vert \vert {\hat{X}}_{d , MAW}^{( i )} {\vert \vert}^{2}} ) {H}_{m , m}^{( i )} + \\ & ( {ω}_{p} {\sum }_{p ε MAW} {W}_{P}^{′ ( i )} + {ω}_{d} {\sum }_{d ε MAW} {W}_{d}^{′ ( i )} )\end{matrix} \qquad ( 35 )$$

where Nₚ and N_{d} are the number of pilot and data symbols within the MAW, and

$$E \{ \vert \vert {ω}_{p} {\sum }_{p ε MAW} {W}_{P}^{′ ( i )} + {ω}_{p} {\sum }_{d ε MAW} {W}_{d}^{′ ( i )} {\vert \vert}^{2} \} = {N}_{p} {ω}_{p}^{2} \frac{{σ}_{{w}^{′}}^{( i )}}{{E}_{p}} + {N}_{d} {ω}_{d}^{2} \frac{{σ}_{{w}^{′}}^{2}}{{E}_{d}} , \qquad ( 36 )$$

The optimal weight values {ωₚ,ω_{d}}, can be obtained using maximum ratio combining principle, which is mathematically formulated into the following Lagrange multiplier problem:

$$\{ {ω}_{p} , {ω}_{d} \} = {arg min}_{{ω}_{p} , {ω}_{d}} ( {N}_{p} {ω}_{p}^{2} \frac{{σ}_{{w}^{′}}^{2}}{{E}_{p}} + {N}_{d} {ω}_{d}^{2} \frac{{σ}_{{w}^{′}}^{2}}{{E}_{d}} ) + λ ( {N}_{p} {ω}_{p} + {N}_{d} {ω}_{d} \sqrt{\vert \vert {\hat{X}}_{d , MAW}^{( l )} {\vert \vert}^{2}} - 1 ) , \qquad ( 37 )$$

where λ is the Lagrange multiplier. Hence, the optimal weights {ωₚ,ω_{d}} are obtained as:

$$\begin{matrix}{ω}_{p} = \frac{1}{{N}_{p} + {N}_{d} \frac{{E}_{d}}{{E}_{p}} \vert \vert {\hat{X}}_{d , MAW}^{( i )} {\vert \vert}^{2}} , & ( 38 ) \\ {ω}_{d} = \frac{\sqrt{\vert \vert {\hat{X}}_{d , MAW}^{( i )} \vert \vert}}{{N}_{p} \frac{{E}_{p}}{{E}_{d}} + {N}_{d} \vert \vert {\hat{X}}_{d , MAW}^{( i )} {\vert \vert}^{2}} , & ( 39 )\end{matrix}$$

Hence, after weighted MAW, the channel response is re-estimated by soft coded data information and pilot symbols. The proposed weighted MAW method can be applied in both frequency and time domain to take advantage of the channel response correlations in two dimensions. Similar to the initial estimation stage, the channel frequency response after both frequency and time filtering is used in the data detection again for the same set of received signal Y⁽ⁱ⁾. In the next iteration, the decoder will feedback the LLR(\hat{d}⁽ⁱ⁾) to the channel estimator again. This process will continue for a number of iterations. The advantage of this iterative turbo method is that when the data decoding becomes more and more reliable as iterations progress, the soft coded data information acts as new “pilots”. And before the last iteration, the decoded OFDM symbol should look like preamble.

At final iteration, when decoding data information is very reliable, more advanced filters can be used to further improve the channel estimation performance. In the following we present two examples based on Maximum Likelihood (ML) and MMSE principles. For illustrative purpose, OFDM modulation is assumed.

### Final Maximum Likelihood (ML) Estimation Stage

By modeling ICI caused by channel variation within OFDM symbol as Gaussian random process, we now have the equivalent OFDM system model as:

Y⁽ⁱ⁾=X′⁽ⁱ⁾Gh′⁽ⁱ⁾+W′⁽ⁱ⁾, (40)

where X′⁽ⁱ⁾=diag(X⁽ⁱ⁾) is the N×N diagonal matrix whose diagonal elements are the transmitted data over all subcarriers. G is the N×L matrix with element [G]_{n,l}=e^{-j2πnl/N}, 0≦n≦N−1 and 0≦l≦L−1. h′⁽ⁱ⁾ is the equivalent L×1 channel impulse response vector h′⁽ⁱ⁾=[h′₀⁽ⁱ⁾,h′₁⁽ⁱ⁾, . . . , h′_{L-1}⁽ⁱ⁾]^{T} where h′ₗ⁽ⁱ⁾ is given by:

$${h}_{l}^{′ ( i )} = \frac{1}{N} {\sum }_{n = 0}^{N - 1} {h}^{( i )} ( n , l ) , \qquad ( 41 )$$

as shown in equation (8). W′⁽ⁱ⁾ is the equivalent N×1 noise vector with σ_{w′}²=σ_{w}²+σ_{ICI}². If X′⁽ⁱ⁾ is known as in the case of preamble, the LS estimation is given by:

\tilde{H}⁽ⁱ⁾=(X′⁽ⁱ⁾)^{H}Y⁽ⁱ⁾=Gh′⁽ⁱ⁾+(X′⁽ⁱ⁾)^{H}W′⁽ⁱ⁾, (42)

and the MLE is given by:

Ĥ⁽ⁱ⁾=G(G^{H}G)⁻¹G^{H}\tilde{H}⁽ⁱ⁾, (43)

Hence, as the coded soft data information becomes reliable in the last iteration, the OFDM symbol should work like a preamble. The final output of iterative maximum likelihood channel estimation is given by:

$${\hat{H}}^{( i )} = {G ( {G}^{H} G )}^{- 1} {G}^{H} {\hat{X}}^{′ ( i )} {Y}^{( i )} = \frac{1}{N} {GG}^{H} {\hat{X}}^{′ ( i )} {Y}^{( i )} , \qquad ( 44 )$$

where \hat{X}′⁽ⁱ⁾ is soft coded OFDM symbol from the last second iteration with pilot tones.

### Alternative Final Minimum Mean-Square Error (MMSE) Estimation Stage

By modeling ICI caused by channel variation within OFDM symbol as Gaussian random process, we now have the equivalent OFDM system model as:

Y⁽ⁱ⁾=X′⁽ⁱ⁾Gh′⁽ⁱ⁾+W′⁽ⁱ⁾, (40′)

where X′⁽ⁱ⁾=diag(X⁽ⁱ⁾) is the N×N diagonal matrix whose diagonal elements are the transmitted data over all subcarriers. G is the N×L matrix with element [G]_{n,l}=e^{-j2πnl/N}, 0≦n≦N−1 and 0≦l≦L−1. h′⁽ⁱ⁾ is the equivalent L×1 channel impulse response vector h′⁽ⁱ⁾=[h′₀⁽ⁱ⁾,h′₁⁽ⁱ⁾, . . . , h′_{L-1}⁽ⁱ⁾]^{T} where h′ₗ⁽ⁱ⁾ is given by:

$${h}_{l}^{′ ( i )} = \frac{1}{N} {\sum }_{n = 0}^{N - 1} {h}^{( i )} ( n , l ) , \qquad ( {41}^{′} )$$

as shown in (8). W′⁽ⁱ⁾ is the equivalent N×1 noise vector with σ_{w′}²=σ_{w}²+σ_{ICI}². If X′⁽ⁱ⁾ is known as in the case of preamble, the LS estimation is given by:

\tilde{H}⁽ⁱ⁾=(X′⁽ⁱ⁾)^{H}Y⁽ⁱ⁾=Gh′⁽ⁱ⁾+(X′⁽ⁱ⁾)^{H}W′⁽ⁱ⁾, (42′)

and the MMSE is given by:

Ĥ⁽ⁱ⁾=GR_{h′h′}(G^{H}GR_{h′h′}+σ_{w′}²I_{L})⁻¹G^{H}\tilde{H}⁽ⁱ⁾=GR_{h′h′}(NR_{h′h′}+σ_{w′}²I_{L})⁻¹G^{H}\tilde{H}⁽ⁱ⁾, (43′)

where R_{h′h′}=E{h′h′^{H}}=diag(αₗ) is the L×L covariance matrix of h′ based on the WSSUS assumption, the fading coefficients in different path are statistically independent zero mean complex Gaussian random variable. I_{L} is the L×L identity matrix, and

G^{H}G=NI_{L}.

Hence, as the coded soft data information becomes reliable in the last iteration, the OFDM symbol should work like preamble. The final output of iterative MMSE channel estimation is given by:

Ĥ⁽ⁱ⁾=GR_{h′h′}(NR_{h′h′}+σ_{w′}²I_{L})⁻¹G^{H}\hat{X}⁽ⁱ⁾Y⁽ⁱ⁾, (44′)

where \hat{X}′⁽ⁱ⁾ is soft coded OFDM symbol from the last second iteration with pilot tones.

### Mean Square Error Analysis of Iterative Turbo Maximum Likelihood Channel Estimation (MLE)

It is difficult to analyze the MSE of the proposed iterative turbo maximum likelihood channel estimation because of the exchange of soft information and MAP decoder. Instead, we are going to derive the lower bound of MSE for MLE. MLE is known as the MVU estimator, which is the optimal estimator for deterministic quantity. The performance of MLE is lower bounded by CRLB. If the proposed iterative turbo maximum likelihood channel estimation can achieve CRLB, it means that no further improvement is possible. Extended from (43),

Ĥ⁽ⁱ⁾=H⁽ⁱ⁾+G(G^{H}G)⁻¹G^{H}X′⁽ⁱ⁾W′⁽ⁱ⁾, (45)

With the MLE, the N×1 vector H⁽ⁱ⁾ is considered as constant, and the expectation is taken over the white Gaussian noise, i.e.:

E{Ĥ⁽ⁱ⁾}=H⁽ⁱ⁾, (46)

Hence, the covariance matrix of Ĥ⁽ⁱ⁾ is given by:

$$\begin{matrix}{C}_{{\hat{H}}^{( i )}} = E \{ \vert \vert {\hat{H}}^{( i )} - {H}^{( i )} {\vert \vert}^{2} \} \\ = E \{ \vert \vert {G ( {G}^{H} G )}^{- 1} {G}^{H} {X}^{′ ( i )} {W}^{′ ( i )} {\vert \vert}^{2} \} \\ = {σ}_{{w}^{′}}^{( l )} G ( {( {G}^{H} G )}^{- 1} ) {G}^{H} = \frac{{σ}_{{w}^{′}}^{2}}{N} {GG}^{H} ,\end{matrix} \qquad ( 47 )$$

The average MSE is given by:

$$M S E = \frac{1}{N} Tr ( {C}_{{\hat{H}}^{( i )}} ) = \frac{1}{N} Tr ( \frac{{σ}_{{w}^{′}}^{2}}{N} {GG}^{H} ) = \frac{{σ}_{{w}^{′}}^{2} L}{N} , \qquad ( 48 )$$

where Tr(•) is the trace operation.

### Mean Square Error Analysis of Iterative Turbo Minimum Mean Square Error Channel Estimation (MMSEE)

With the MMSEE, the covariance matrix of Error! Objects cannot be created from editing field codes. is given by:

Error! Objects cannot be created from editing field codes. (47′)

The average MSE is given by:

Error! Objects cannot be created from editing field codes. (48′)

where Error! Objects cannot be created from editing field codes. is the trace operation.

### Complexity Analysis of Iterative Turbo Maximum Likelihood Channel Estimation

The computational complexity of the proposed iterative turbo maximum likelihood channel estimation is approximated by the number of complex multiplications over the three stages. Assume there are altogether M iterations. In the initial estimation stage, pilot estimation requires Nₚ complex multiplications, where Nₚ is the number of pilot tones. To obtain the coarse channel frequency response at data tones, the linear interpolation between pilot tones requires 2×(N−Nₚ) complex multiplications. In the frequency-domain filtering, the smooth average operation only requires N complex multiplication. In time-domain filtering, N_{MAW}^{TD} complex multiplication is required for each subcarrier, where N_{MAW}^{TD} is the time-domain MAW size.

In the iterative estimation stage, every iteration requires the same computational complexity. More specifically, in each iteration, the soft data channel estimation requires N−Nₚ complex multiplications. For each subcarrier, the calculation of ωₚ,ω_{d} coefficients requires N multiplications, frequency-domain filtering requires N_{MAW}^{FD} complex multiplications, where N_{MAW}^{FD} is the frequency-domain MAW size, and time-domain filtering requires N_{MAW}^{FD} complex multiplications.

In the final maximum likelihood estimation stage, only soft data channel estimation and MLE operation are performed. Similar to iterative estimation stage, soft data channel estimation requires N−Nₚ complex multiplications. MLE operation requires N² complex multiplications.

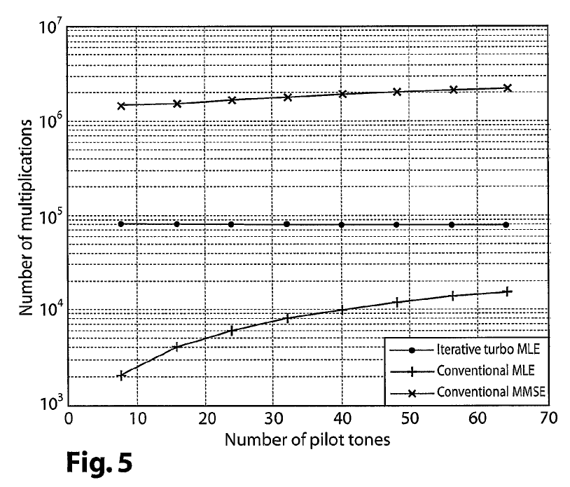

Table I shows the summary of number of complex multiplications involved in each stage. Table II shows the complexity of conventional pilot-aided MLE and MMSE channel estimation, where N_{CP} is the length of CP, which representing the maximum channel delay spread. It is obvious that the computational complexity is O(N²) for the proposed iterative maximum likelihood channel estimation, which is almost as same as conventional MLE with all subcarriers dedicated to pilots. In other words, with same computational complexity, the proposed iterative maximum likelihood channel estimation can achieve the performance of MLE in the preamble case, which is the best performance that can be achieved. Meanwhile, the complexity will be reduced when the number of pilot tones increases. Furthermore, since there is no matrix inversion involved, the computational complexity of the proposed iterative maximum likelihood channel estimation is quite lower than conventional MMSE channel estimation. FIG. 5 shows the complexity comparison among above three channel estimation techniques, where M=6, N=256, N_{MAW}^{TD}=3, N_{MAW}^{FD}=9 and N_{CP}=64.

TABLE I
NUMBER OF COMPLEX MULTIPLICATIONS

| Operations | First Stage | Second Stage per iteration | Final Stage |
|---|---|---|---|
| Pilot Estimation | Nₚ | 0 | 0 |
| Soft Data Estimation | 0 | N − Nₚ | N − Nₚ |
| Linear Interpolation | 2 × (N − Nₚ) | 0 | 0 |
| ωₚ, ω_{d} Calculation | 0 | N | 0 |
| Frequency-domain Filtering | N | N × N_{MAW}^{FD} | 0 |
| Time-domain Filtering | N × N_{MAW}^{TD} | N × N_{MAW}^{TD} | 0 |
| Maximum Likelihood Estimation | 0 | 0 | N² |
| Subtotal for each stage | 3N − Nₚ + N × N_{MAW}^{TD} | (M − 2) × [2N − Nₚ + N × (N_{MAW}^{FD} + N_{MAW}^{TD})] | N² + N − Nₚ |

| | |
|---|---|
| Total | N² + N × [2M + (M − 1) × N_{MAW}^{TD} + (M − 2) × N_{MAW}^{FD}] − M × Nₚ |

TABLE II
COMPLEXITY OF CONVENTIONAL PILOT-AIDED
CHANNEL ESTIMATION

| | Number of complex multiplications |
|---|---|
| Conventional | Nₚ + N × Nₚ |
| MLE | |
| Conventional | O(N_{CP}³) + N_{CP}² × N + N_{CP} × N × (Nₚ + 1) + N × Nₚ + Nₚ |
| MMSE | |

### Simulation

### Simulation Setup

In this section, to demonstrate the performance of the proposed iterative turbo maximum likelihood channel estimation technique, we consider an OFDM system with N=256 subcarriers, and 8 pilot tones. The carrier frequency is 5 GHz, and the bandwidth is 5 MHz. The IMT-2000 vehicular-A channel [7] is generated by Jakes model, with exponential decayed power profile {0, −1, −9, −10, −15, −20} in dB and relative path delay {0, 310, 710, 1090, 1730, 2510} in ns. The vehicular speed is 333 kmh, which is translated to a Doppler frequency of fₘ=1540.125 Hz. The CP duration is 2.8 μs. Hence, the OFDM symbol duration is T_{sym}=NTₛ+CP=54 μs. fₘT_{sym}≈0.08, the symbol duration is approximately 8% of channel coherent time. Hence, the ICI due to mobility can be treated as white Gaussian noise for the SNR region of interest.

A rate-½ (5,7)₈ convolutional code is used for channel coding. The random interleaver is adopted in the simulation and the modulation scheme is QPSK. The maximum number of iterations is set to 6. There are 10 OFDM symbols per frame transmission, which means that the preamble is inserted every 10 OFDM symbols. The energy of pilot symbol is same as data symbol. Pilot tones are inserted evenly distributed across subcarriers with pilot interval of 32. The frequency-domain MAW size is set to 9 and time-domain MAW size is set to 3 to make sure that the correlation of channel frequency response within the MAW is sufficient high. The OFDM system with proposed iterative channel estimation technique is also compared with conventional pilot-aided channel estimation by using 64 pilot tones. Performance comparisons are made in terms of the OFDM BER, symbol error rate (SER), frame error rate (FER) and the MSE, which is defined as:

$$M S E = \frac{1}{N} E \{ \vert \vert {\hat{H}}^{( i )} - {H}^{( i )} {\vert \vert}^{2} \} . \qquad ( 49 )$$

In the case of iterative turbo MLE, performance of MSE will be compared to CRLB, when all subcarriers are dedicated for pilot tones. In other words, it is the preamble case which has the best performance that a MLE can achieve. Similarly, in the case of iterative turbo MMSEE, performance of MSE will be compared to case of preamble.

### Numerical Results

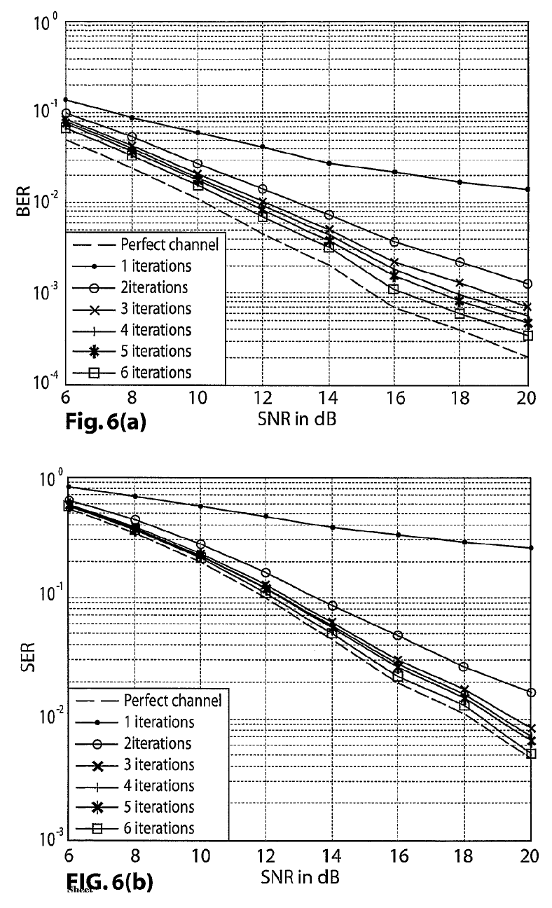

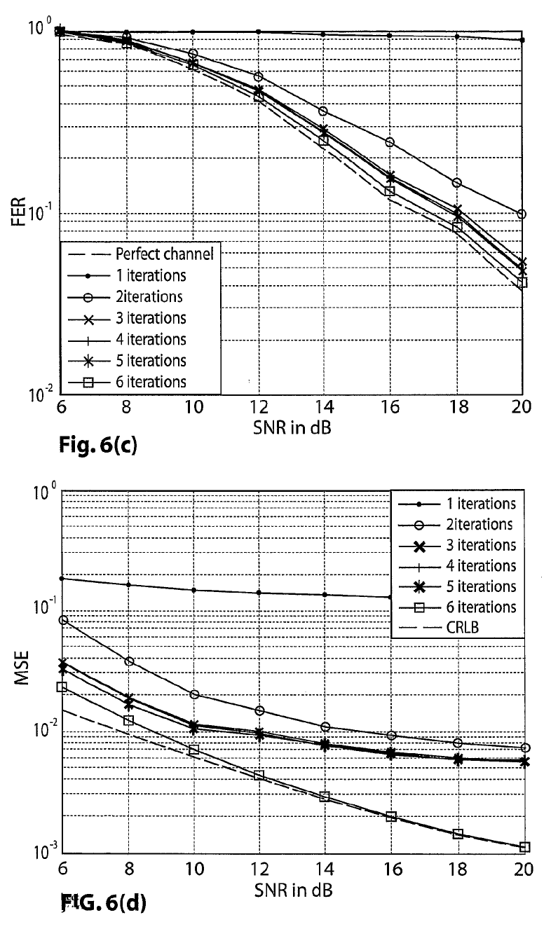

FIG. 6 shows the performances of the OFDM system with proposed iterative turbo ML channel estimation over a number of iterations. As shown in FIG. 6(d), in the last iteration, the MSE of proposed iterative turbo ML channel estimation approaches CRLB. This guarantees that BER, SER and FER approaches those with perfect channel information as shown in FIG. 6(a), FIG. 6(b), and FIG. 6(c) respectively. This is because the proposed iterative turbo ML channel estimation makes use of preamble, pilot and soft coded data symbols to estimate the channel frequency response. As the iterations progress, the soft coded data symbols becomes more and more reliable, which act as new “pilot” symbols in the next iteration. On the other hand, conventional MLE only uses the limited number of pilot tones.

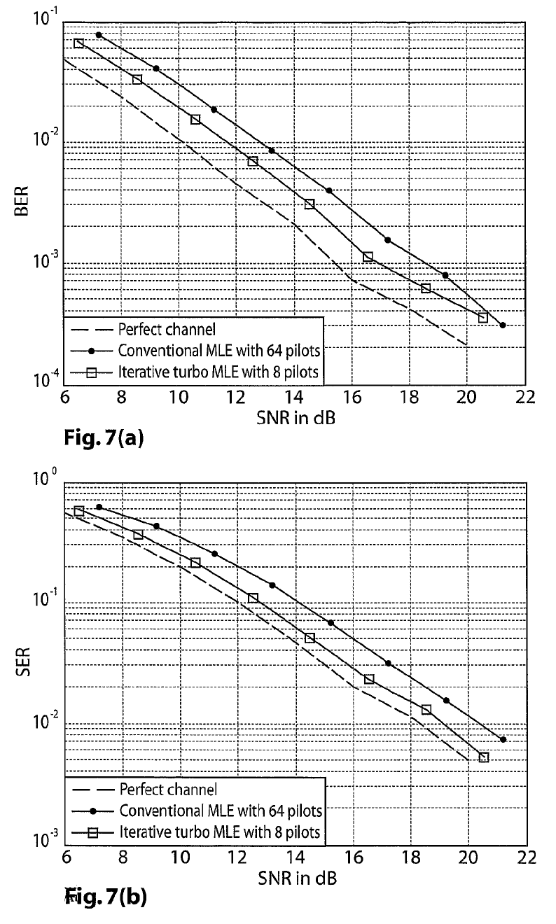

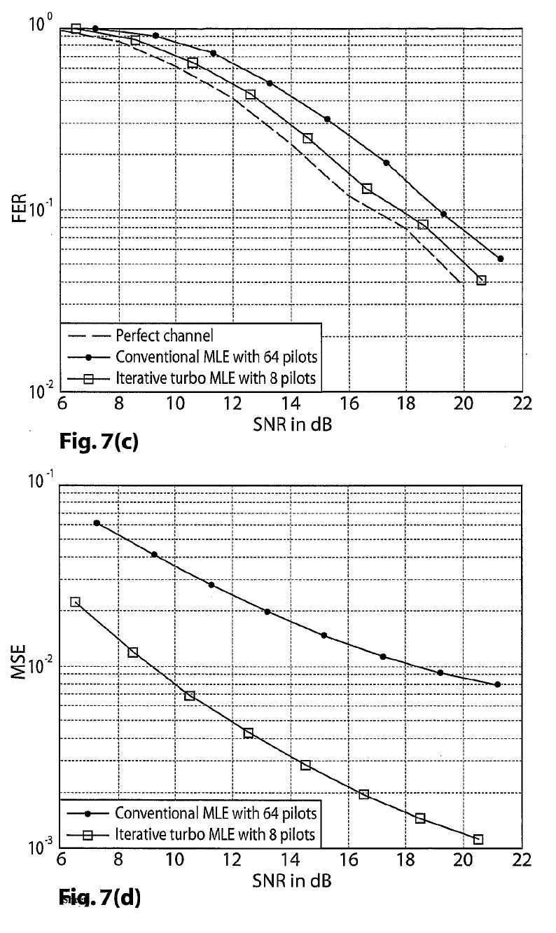

FIG. 7 shows the BER, SER, FER and MSE performances between the OFDM system with proposed iterative turbo ML channel estimation and OFDM system with conventional pilot-aided ML channel estimation with 64 pilot tones. The performance curves are shifted to compensate the SNR loss due to preamble and pilot tones. It shows that the proposed iterative turbo ML channel estimation always has better performance. This observation also implies that the proposed iterative turbo ML channel estimation is both power and spectral efficient.

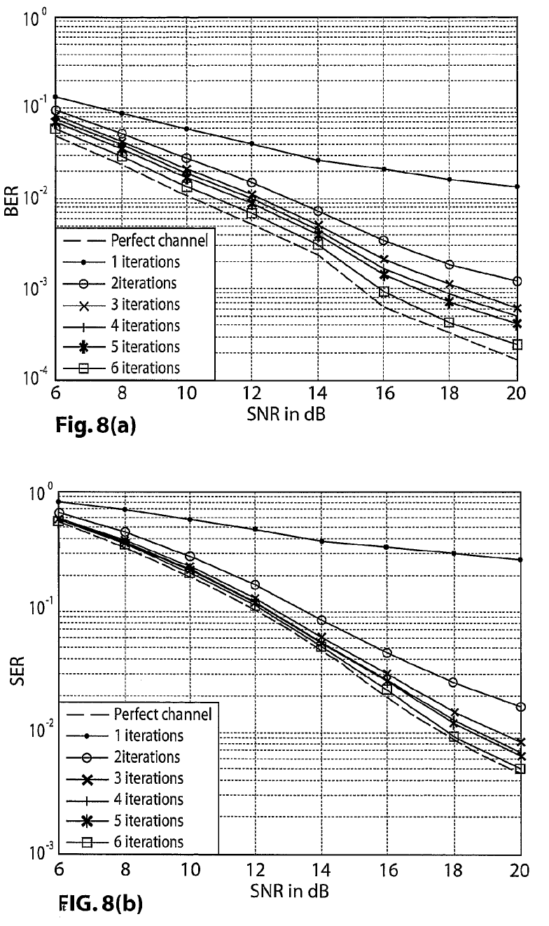

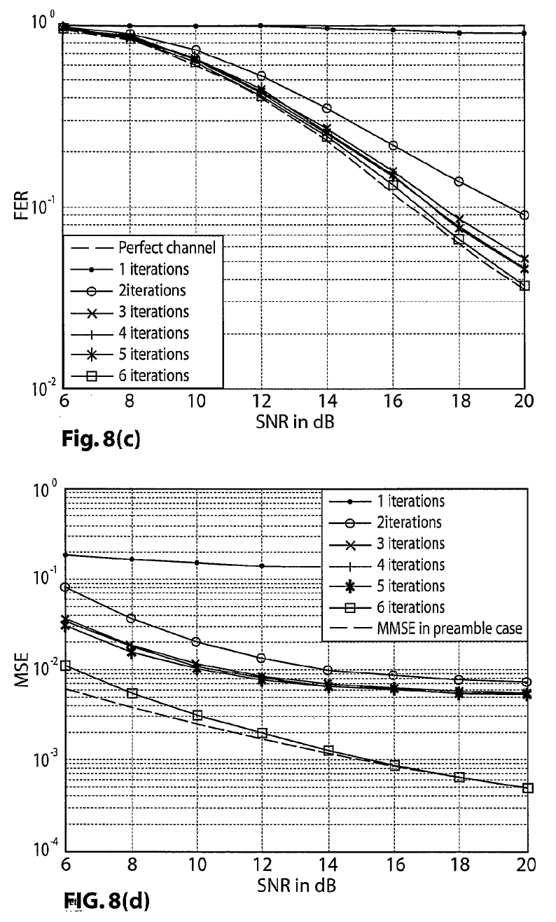

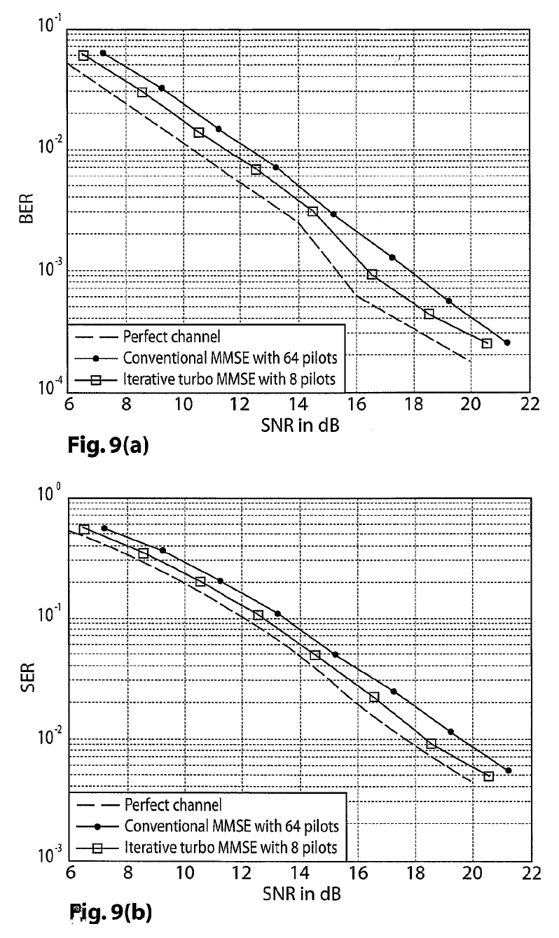

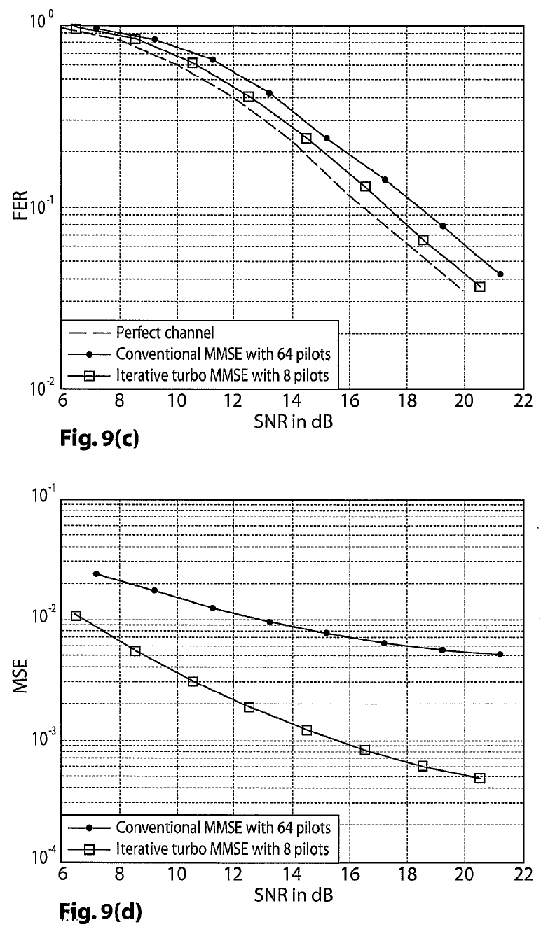

FIG. 8 shows the performances of the OFDM system with proposed iterative turbo MMSEE channel estimation over a number of iterations. FIG. 9 shows the BER, SER, FER and MSE performances between the OFDM system with proposed iterative turbo MMSEE channel estimation and OFDM system with conventional pilot-aided MMSEE channel estimation with 64 pilot tones. Same conclusion can be drawn.

1. A method of channel estimation and data detection for transmissions over a multipath channel, comprising the following steps:
receiving a transmission over a communications channel, wherein the transmission comprises a series of frames wherein each frame comprises a series of blocks of information data, or symbols, wherein each symbol is divided into multiple samples which are transmitted in parallel using multiple subcarriers, and wherein pilot tones are inserted into each symbol to assist in channel estimation and data detection; I decoding a symbol of the received transmission by retrieving pilot tones from it and using these to estimate variations in the channel frequency response using an iterative maximum likelihood channel estimation process, in which the estimation process comprises the following steps:
in a first iteration, deriving soft decoded data information, that is information having a confidence value or reliability associated with it, from the estimates of the channel frequency response for the symbol obtained from pilot tones;
and, in at least a second iteration using the soft decoded data information as virtual pilot tones together with the pilot tones to re-estimate the channel frequency response for the symbol.

2. The method according to claim 1, wherein in the first iteration a coarse channel frequency response is obtained by tracking the channel variation through low-pass filtering the channel dynamics obtained at pilot positions.

3. The method according to claim 2, wherein frequency domain moving average window (MAW) filtering is applied after the first iteration to reduce the estimation noise.

4. The method according to claim 1, wherein in the second iteration both pilot symbols and soft decoded data information are used jointly to estimate channel frequency response.

5. The method according to claim 4, wherein time and frequency domain MAW filtering is applied after the second iteration to reduce the estimation noise.

6. The method according to claim 1, wherein a maximum ratio combining (MRC) principle is used to derive optimal weight values for the channel estimates in frequency domain and time domain MAW filtering.

7. The method according to claim 1, wherein after the second and subsequent iterations a maximum likelihood (ML) principle may be used to obtain the final channel estimates.

8. The method according to claim 1, wherein after the second and subsequent iterations a minimum mean-square error (MMSE) principle is used to obtain the final channel estimates.

9. The method according to claim 1, wherein the iteration process is performed in the frequency domain.

10. The method according to claim 1, wherein in each case time domain MAW filtering is applied, after the frequency domain filtering to further reduce the estimation noise.

11. The method according to claim 10, wherein the filtering weights are determined by the correlation between consecutive symbols.

12. The method according to claim 1, wherein the procedure is repeated for a third iteration.

13. The method according to claim 1, wherein a preamble is included in each frame transmitted, and the preamble, pilots and soft decoded data are all used to track the channel frequency response in every symbol.

14. The method according to claim 13, wherein the channel estimates are the joint weighting and averaging among these three attributes.

15. The method according to claim 1, wherein a turbo code instead of convolutional code is used in data decoding.

16. The method according to claim 1, wherein low density parity check (LDPC) code instead of convolutional code is used in data decoding.

17. The method according to claim 1, applied to OFDM, MIMO-OFDM or MC-CDMA.

18. The method according to claim 1, wherein frequency offset and timing offset estimation and tracking are incorporated within the iterative channel estimation.

19. A receiver able to estimate channel variation and detect data received over a multipath channel, the receiver comprising:
a reception port to receive a transmission over a communications channel, wherein the transmission comprises a series of frames wherein each frame comprises a series of blocks of information data, or symbols, wherein each symbol is divided into multiple samples which are transmitted in parallel using multiple subcarriers, and wherein pilot tones are inserted into each symbol to assist in channel estimation and data detection;
a decoding processor to decode a symbol of the received transmission by retrieving pilot tones from it and using these to estimate variations in the channel frequency response using an iterative maximum likelihood channel estimation process, in which the processor performs the estimation process comprises the following steps:
in a first iteration, deriving soft decoded data information, that is information having a confidence value or reliability associated with it, from the estimates of the channel frequency response for the symbol obtained from pilot tones;
and, in at least a second iteration using the soft decoded data information as virtual pilot tones together with the pilot tones to re-estimate the channel frequency response for the frame.

20. Computer software to perform the decoding steps claimed in claim 1.
